(19) United States
(12) Patent Application Publication
(10) Pub. No.: US 2012/0215869 A1
(43) Pub. Date: Aug. 23, 2012

(54) Multimedia Message Transmission Method and Apparatus Thereof, and Domain Name Server

(75) Inventor: Xiang Huang, Shenzhen (CN)

(73) Assignee: ZTE CORPORATION, Shenzhen City, Guangdong Province (CN)

(21) Appl. No.: 13/503,178

(22) PCT Filed: Mar. 24, 2010
(86) PCT No.: PCT/CN2010/071261

§ 371 Date: Apr. 20, 2012

(30) Foreign Application Priority Data
Oct. 20, 2009 (CN) 200910175176.X

(51) Int. Cl. G06F 15/16

(52) U.S. Cl. 709/206

(57) ABSTRACT

The present invention discloses a multimedia message transmitting method, a multimedia message transmitting device, and a domain name system server. The method includes: the multimedia message transmitting device transmitting a multimedia message transmitting request to the domain name system server after receiving multimedia message submitted by a multimedia message transmitting party; and receiving identification information of multimedia message centers returned by the domain name system server, wherein the identification information is identification information of a multimedia message center selected by the domain name system server from various multimedia message centers after receiving the transmitting request; and the multimedia message transmitting device transmitting the received multimedia message to the multimedia message center identified by the received identification information.

### TECHNICAL FIELD

The present invention relates to the field of multimedia communication technologies, and in particular, to a multimedia message transmitting method, a multimedia message transmitting device, and a domain name system server.

### BACKGROUND OF THE RELATED ART

With the popularity of multimedia message terminals and the expansion of Service Provider (SP) traffic, the multimedia message is increasingly applied to daily lives and works, and multimedia message services have been vigorously developed. To this end, various operators establish a number of multimedia message centers respectively. The multimedia message centers are the core of the whole multimedia message system, and storing and processing the multimedia message comprise input/output of the multimedia message, address resolution, notifying, reporting etc., and meanwhile, the multimedia message center will be responsible for operations such as transfer of the multimedia message between different multimedia message centers etc. At present, all the various operators take a method for pre-setting a multimedia message center to which a user belongs, i.e., when each user transmits and receives multimedia message, the process must be performed by a preset multimedia message center. A flowchart of an existing multimedia message transmitting method is shown in FIG. 1, which comprises the following steps.

In S101, a transmitting party transmits multimedia message to a specified multimedia message center.

In S102, the specified multimedia message center (i.e., a multimedia message center where the transmitting party is located) searches for an address of a multimedia message center where a receiving party is located after receiving the multimedia message.

In S103, the multimedia message center where the transmitting party is located transmits the received multimedia message to the multimedia message center where the receiving party is located according to the searched address.

In S104, the multimedia message center where the receiving party is located transmits a download notification to the receiving party after receiving the multimedia message.

In S105, the receiving party downloads the multimedia message from the multimedia message center where the receiving party is located after receiving the download notification.

In S106, the receiving party transmits a download complete report to the multimedia message center where the receiving party is located after completing the download.

In S107, the multimedia message center where the receiving party is located transmits a transmission complete report to the transmitting party through the multimedia message center where the transmitting party is located, and performs related charging processing operations.

In the existing multimedia message transmitting system, both the transmitting party and the receiving party fixedly belong to a certain multimedia message center, and cannot be dynamically adjusted. Thus, for the whole multimedia message transmitting system, as the number of users of various multimedia message centers is preset, there may be a condition that users belonging to a certain multimedia message center or certain multimedia message centers extensively use multimedia messages while users belonging to other multimedia message centers seldom use the multimedia messages within a certain time, and therefore a case that traffic is imbalanced among various multimedia message centers occurs. In order to solve the problem that the traffic is imbalanced, based on the current multimedia message transmitting method, it can be ensured that the traffic of the multimedia message center does not exceed the processing capability thereof only if more multimedia message centers are established to reduce the number of users of various multimedia message centers; however, this will necessarily results in a waste of device resources.

### SUMMARY OF THE INVENTION

The main purpose of the present invention is to provide a multimedia message transmitting method, a multimedia message transmitting device, and a domain name system server, which are used to solve the problem of a waste of device resources due to the unbalance of traffic processed by the multimedia message centers, which exists in the related art.

The embodiment of the present invention uses the following technical schemes:

A multimedia message transmitting method comprises: a multimedia message transmitting device transmitting a multimedia message transmitting request to a domain name system server after receiving multimedia message submitted by a multimedia message transmitting party; receiving identification information of multimedia message centers returned by the domain name system server, wherein, the identification information is identification information of a multimedia message center selected from various multimedia message centers by the domain name system server after receiving the transmitting request; and the multimedia message transmitting device transmitting the received multimedia message to the multimedia message center identified by the received identification information.

A multimedia message transmitting device comprises: a multimedia message receiving unit, configured to receive multimedia message submitted by a multimedia message transmitting party; a request transmitting unit, configured to transmit a multimedia message transmitting request to a domain name system server after the multimedia message receiving unit receives the multimedia message submitted by the multimedia message transmitting party; an identification information receiving unit, configured to receive identification information of multimedia message centers returned by the server; and a multimedia message transmitting unit, configured to transmit the multimedia message received by the multimedia message receiving unit to a multimedia message center identified by the identification information received by the identification information receiving unit.

A domain name system server comprises: a request receiving unit, configured to receive a multimedia message transmitting request transmitted by a multimedia message transmitting device; a selecting unit, configured to select a multimedia message center from various multimedia message centers after the request receiving unit receives the transmitting request; and an identification information feedback unit, configured to feed back identification information of the multimedia message center selected by the selecting unit to the multimedia message transmitting device.

Compared with the related art, the multimedia message transmitting scheme provided by the embodiments of the present invention can dynamically allocate services according to the running conditions of various multimedia message centers, thus balancing the traffic of various multimedia message centers, helping to make full use of the processing abilities of various multimedia message centers, and improving the availability of device resources.

### BRIEF DESCRIPTION OF DRAWINGS

FIG. 1 is a flowchart of an existing multimedia message transmitting method;

FIG. 2 is a flowchart of a first embodiment of a multimedia message transmitting method according to the present invention;

FIG. 3 is a flowchart of a second embodiment of a multimedia message transmitting method according to the present invention;

FIG. 4 is a structural diagram of an embodiment of a multimedia message transmitting device according to the present invention; and

FIG. 5 is a structural diagram of an embodiment of a DNS server according to the present invention.

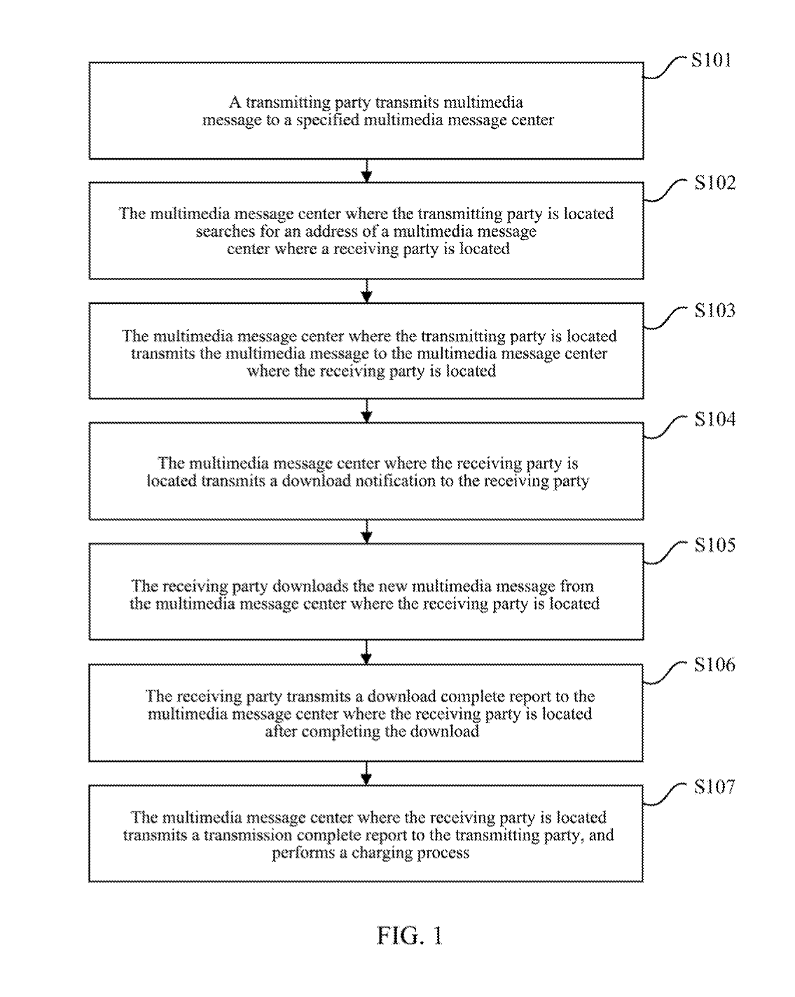

### PREFERRED EMBODIMENTS OF THE PRESENT INVENTION

In the scheme of transmitting multimedia message according to the present invention, by a Domain Name System (DNS) server interacting with all multimedia message centers in the system by information, selecting a multimedia message center according to the information obtained by the interaction and allocating the multimedia message transmitting party to the selected multimedia message center, the scheme provided by the present invention can dynamically allocate the multimedia message transmitting party according to the running conditions of various multimedia message centers in the system, thus being able to make full use of the processing ability of various multimedia message centers, and therefore it solves the problem of a waste of device resources of the multimedia message center due to the unbalance of traffic processed by the multimedia message center in the multimedia message transmitting system, which exists in the related art. In addition, the scheme of transmitting multimedia message provided by the present invention can further avoid whole cutover of users when increasing the multimedia message centers, and thus can avoid manually adjusting operations of multimedia message centers to which the users belong when a fault occurs in several multimedia message centers, thus enhancing efficiency of the multimedia message transmission.

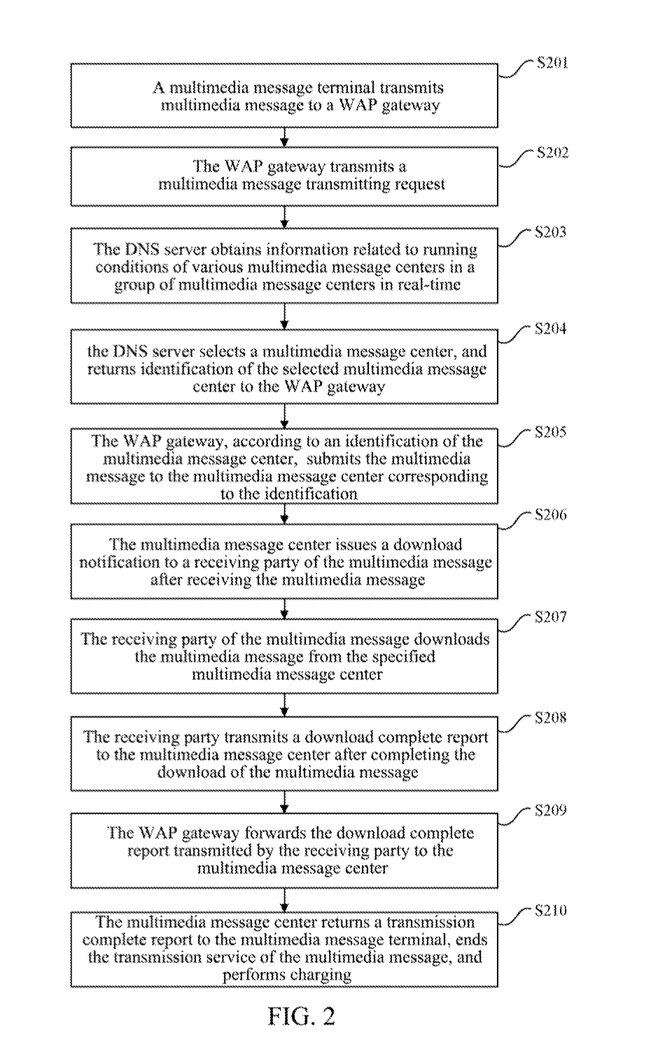

FIG. 2 is a flowchart of a first embodiment of a multimedia message transmitting method from one multimedia message terminal to another multimedia message terminal according to the present invention. As shown in FIG. 2, the method specifically comprises the following steps.

In S201, a user transmits multimedia message to a Wireless Application Protocol (WAP) gateway through a multimedia message terminal. At this time, the user is a multimedia message transmitting party, and the WAP gateway is a multimedia message transmitting device.

In S202, the WAP gateway transmits a multimedia message transmitting request to a DNS server after confirming that the message is multimedia message.

In S203, the DNS server obtains information related to running conditions of various multimedia message centers in the communication network through interacting with various multimedia message centers by information, and specifically, the DNS server can interact with the various multimedia message centers in the communication network through the Internet by information, and the interacted information comprises information related to the running conditions of the multimedia message centers such as traffic currently processed by the various multimedia message centers, current network throughout, used link information, service processing delay information etc.

It should be illustrated that the DNS server can determine various multimedia message centers which are running currently and various multimedia message centers which are not running currently by means of heartbeat message etc., and in addition, the DNS server can discover a new multimedia message center by means of configuration etc.; and here, the interaction between the DNS server and various multimedia message centers is not limited to the above means, and similarly comprises other interaction means which is able to implement the above functions.

In S204, the DNS server selects a multimedia message center according to the current related information of various multimedia message centers obtained by the above interaction, and then returns an identification of the selected multimedia message center to the WAP gateway.

The identification of the multimedia message center can be a Uniform/Universal Resource Locator (URL) address of the multimedia message center or an Identity (ID) number of the multimedia message center, or can also be other identification information which can uniquely identify the multimedia message center.

In the present step, the process that the DNS server obtains the current related information of various multimedia message centers according to the above interaction, and returns the identification of the selected multimedia message center to the WAP gateway, can be, but is not limited to the following several implementation modes.

In the first mode, the DNS server interacts with various multimedia message centers, obtains current network throughout of various multimedia message centers and maximum network throughout supported by the various multimedia message centers, determines a multimedia message center with the maximum idle throughout according to the obtained current network throughout of various multimedia message centers and maximum network throughout supported by the various multimedia message centers, and returns a URL or ID of the multimedia message center to the WAP gateway.

In the second mode, the DNS server interacts with various multimedia message centers to obtain currently processed traffic of various multimedia message centers and maximum traffic supported by the various multimedia message centers, determines a multimedia message center with the maximum idle processing capability according to the obtained currently processed traffic of various multimedia message centers and maximum traffic supported by the various multimedia message centers, and returns a URL or ID of the multimedia message center to the WAP gateway.

In the third mode, the DNS server interacts with various multimedia message centers to obtain current service processing delays of various multimedia message centers, determines a multimedia message center with a minimum service processing delay according to the obtained current service processing delays of various multimedia message centers, and returns a URL or ID of the multimedia message center to the WAP gateway.

In the fourth mode, the DNS server interacts with various multimedia message centers to obtain change conditions of current traffic of various multimedia message centers, predicts a multimedia message center with a maximum reduction of the traffic according to the obtained change conditions of currently traffic of various multimedia message centers, and returns a URL or ID of the multimedia message center to the WAP gateway.

In S205, the WAP gateway, according to an identification of the multimedia message center returned by the DNS server, submits the multimedia message submitted by the user to the multimedia message center corresponding to the identification.

In S206, the multimedia message center issues a download notification to a receiving party of the multimedia message after receiving the multimedia message, wherein, an transmission identification transaction_id in the notification comprises identification information of the multimedia message center, such as mmscid, mmscip etc., and the multimedia message center can be uniquely determined according to the identification information.

In S207, the receiving party of the multimedia message downloads the multimedia message from the specified multimedia message center according to the identification information such as mmscid, mmscip etc. of the multimedia message center contained in the transmission identification transaction_id in the notification, after receiving the download notification.

In S208, the receiving party transmits a download complete report to the multimedia message center after completing the download of the multimedia message; and the download complete report can be transmitted through the WAP gateway, and the download complete report comprises the same transmission identification transaction_id as that in the download notification.

In S209, the WAP gateway forwards the download complete report transmitted by the receiving party to the multimedia message center according to the transmission identification transaction_id contained in the download complete report; and here, the WAP gateway firstly decodes the download complete report, obtains the identification information of the multimedia message center from the transmission identification transaction_id, and determines to which multimedia message center the download complete report should be transmitted.

In S210, the multimedia message center returns a transmission complete report to the multimedia message terminal after receiving the download complete report, ends the process of transmitting the multimedia message, and completes related charging operations.

In the scheme of transmitting multimedia message illustrated in FIG. 2, the contact between a multimedia message terminal and a mobile network is implemented through a WAP gateway. Here, a multimedia message terminal of a transmitting party and a multimedia message terminal of a receiving party can be terminals of a second generation mobile communication system or a third generation mobile communication system, and similarly, can be other types of multimedia message terminals.

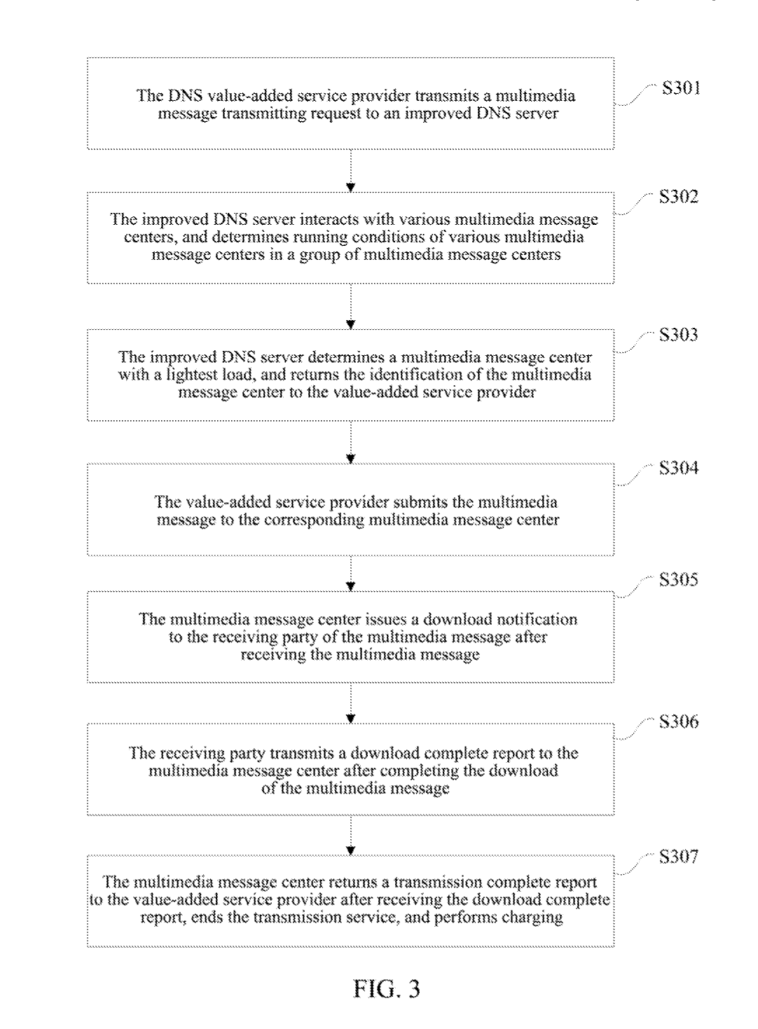

FIG. 3 is a flowchart of an embodiment of a method for transmitting multimedia message to a user terminal by a value-added service provider according to the present invention. As shown in FIG. 3, the method comprises the following steps.

In S301, the value-added service provider transmits a multimedia message transmitting request to a DNS server using a multimedia message transmitting device, and at this time, the value-added service provider is a multimedia message transmitting party.

In S302, the DNS server interacts with various multimedia message centers, obtains information related to running conditions of various multimedia message centers in the communication network, and specifically, the DNS server can interact with the various multimedia message centers in the communication network through the Internet by the information, and the interacted information comprises information related to the running conditions of the multimedia message centers such as currently processed traffic, current network throughout, used link information, service processing delay information etc.

The DNS server can determine various multimedia message centers which are running currently and various multimedia message centers which are not running currently by means of heartbeat message etc., and in addition, the DNS server can discover a new multimedia message center by means of configuration etc.; and here, the interaction between the DNS server and various multimedia message centers is not limited to the above means, and similarly comprises other similar interaction means which is able to implement the above functions.

In S303, the DNS server selects a multimedia message center according to the current related information of various multimedia message centers obtained by the above interaction, and then returns the identification of the selected multimedia message center which is most suitable to the multimedia message transmitting device of the value-added service provider. The selection process can be, but is not limited to the following several implementation modes.

In the first mode, the DNS server interacts with various multimedia message centers, obtains current network throughout of various multimedia message centers and maximum network throughout supported by the various multimedia message centers, determines a multimedia message center with the maximum idle throughout according to the obtained current network throughout of various multimedia message centers and maximum network throughout supported by the various multimedia message centers, and returns a URL or ID of the multimedia message center to the value-added service provider.

In the second mode, the DNS server interacts with various multimedia message centers to obtain currently processed traffic of various multimedia message centers and maximum traffic supported by the various multimedia message centers respectively, determines a multimedia message center with the maximum idle processing capability according to the obtained current processing traffic of various multimedia message centers and maximum traffic supported by the various multimedia message centers, and returns a URL or ID of the multimedia message center to the value-added service provider.

In the third mode, the DNS server interacts with various multimedia message centers to obtain current service processing delays of various multimedia message centers, determines a multimedia message center with a minimum service processing delay according to the obtained current service processing delays of various multimedia message centers, and returns a URL or ID of the multimedia message center to the value-added service provider.

In the fourth mode, the DNS server interacts with various multimedia message centers to obtain change conditions of current traffic of various multimedia message centers, predicts a multimedia message center with a maximum reduction of the traffic according to the obtained change conditions of current traffic of various multimedia message centers, and returns a URL or ID of the multimedia message center to the value-added service provider.

In S304, the value-added service provider, according to an identification of the multimedia message center returned by the DNS server, submits the multimedia message submitted by the user to the multimedia message center identified by the identification.

In S305, the multimedia message center issues a download notification to the receiving party of the multimedia message after receiving the multimedia message, wherein, an transmission identification transaction_id in the notification contains identification information of the multimedia message center, such as mmscid, mmscip etc., and the multimedia message center can be uniquely determined according to the identification information.

In S306, the receiving party of the multimedia message downloads the multimedia message from the specified multimedia message center according to the identification information of the multimedia message center contained in the transmission identification transaction_id in the notification after receiving the download notification, and transmits the download complete report to the multimedia message center after completing the download of the multimedia message.

In S307, the multimedia message center returns a transmission complete report to the value-added service provider after receiving the download complete report, ends the process of transmitting the multimedia message, and completes related charging operations.

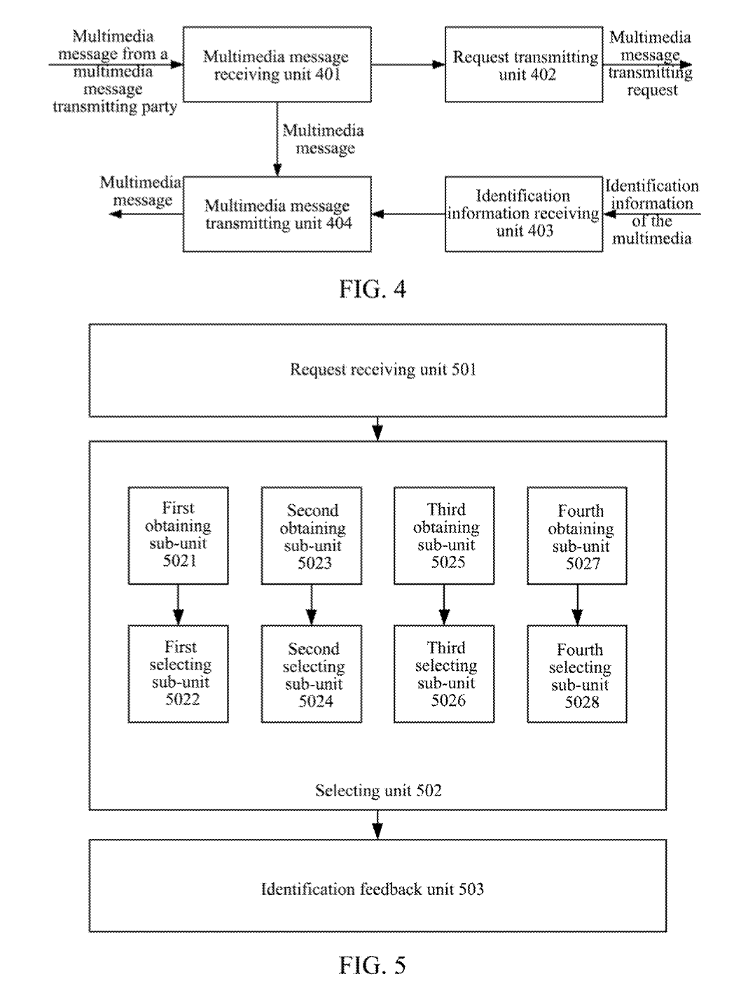

FIG. 4 is a structural diagram of an embodiment of a multimedia message transmitting device according to the present invention. As shown in FIG. 4, the device at least comprises:

a multimedia message receiving unit 401, which is configured to receive multimedia message submitted by a multimedia message transmitting party;

a request transmitting unit 402, which is configured to transmit a multimedia message transmitting request to a DNS server after the multimedia message receiving unit receives the multimedia message submitted by the multimedia message transmitting party;

an identification information receiving unit 403, which is configured to receive identification information of a multimedia message center returned by the DNS server, wherein, the identification information can uniquely identify a multimedia message center identified by itself;

a multimedia message transmitting unit 404, which is configured to transmit the multimedia message received by the multimedia message receiving unit to a multimedia message center identified by the identification information received by the identification information receiving unit.

In the actual applications, the multimedia message transmitting device according to the present invention can be, but is not limited to a WAP gateway receiving multimedia message of a user, a multimedia message transmitting device of a value-added service provider.

FIG. 5 is a structural diagram of an embodiment of a DNS server according to the present invention. As shown in FIG. 5, the DNS server specifically comprises:

a request receiving unit 501, which is configured to receive a multimedia message transmitting request transmitted by a multimedia message transmitting device;

a selecting unit 502, which is configured to select a multimedia message center from various multimedia message centers after the request receiving unit receives the transmitting request.

Wherein, the selecting unit 502 can comprises: a first obtaining sub-unit 5021, configured to obtain current network throughout of the various multimedia message centers and maximum network throughout supported by the various multimedia message centers respectively; and a first selecting sub-unit 5022, configured to select a multimedia message center with the maximum current idle throughout according to the current network throughout of the various multimedia message centers and the maximum network throughout supported by the various multimedia message centers obtained by the first obtaining sub-unit. Alternatively, the selecting unit 502 comprises: a second obtaining sub-unit 5023, configured to obtain currently processed traffic of the various multimedia message centers and maximum processed traffic supported by the various multimedia message centers respectively; and a second selecting sub-unit 5024, configured to select a multimedia message center with the maximum current idle service processing capability according to the currently processed traffic of the various multimedia message centers and the maximum processed traffic supported by the various multimedia message centers obtained by the second obtaining sub-unit. Alternatively, the selecting unit 502 comprises: a third obtaining sub-unit 5025, configured to obtain current service processing delays of the various multimedia message centers respectively; and a third selecting sub-unit 5026, configured to select a multimedia message center with a minimum service processing delay according to the current service processing delays of the various multimedia message centers obtained by the third obtaining sub-unit. Alternatively, the selecting unit 502 comprises: a fourth obtaining sub-unit 5027, configured to obtain change conditions of currently processed traffic of the various multimedia message centers respectively; and a fourth selecting sub-unit 5028, configured to select a multimedia message center with a maximum reduction of the currently processed traffic according to the change conditions of currently processed traffic of the various multimedia message centers obtained by the fourth obtaining sub-unit.

In the actual applications, a multimedia message center can be selected from the various multimedia message centers by using the above one group of an obtaining sub-unit and a selecting sub-unit corresponding to each other.

An identification feedback unit 503 is configured to feed back identification information of the multimedia message center selected by the selecting unit to the multimedia message transmitting device.

Obviously, those skilled in the art can make various changes and variations on the present invention without departing from the spirit and scope of the present invention. Thus, if these modifications and variations of the present invention fall into the scope of the claims of the present invention and the equivalent techniques thereof, the invention is also intended to include these changes and variations.

What is claimed is:

1. A multimedia message transmitting method, comprising:
a multimedia message transmitting device transmitting a multimedia message transmitting request to a domain name system server after receiving multimedia message submitted by a multimedia message transmitting party;
receiving identification information of multimedia message centers returned by the domain name system server, wherein, the identification information is identification information of a multimedia message center selected from the various multimedia message centers by the domain name system server after receiving the transmitting request; and
the multimedia message transmitting device transmitting the received multimedia message to the multimedia message center identified by the received identification information.

2. The multimedia message transmitting method according to claim 1, wherein, the domain name system server selecting a multimedia message center from the various multimedia message centers specifically comprises:
the domain name system server obtaining current network throughout of the various multimedia message centers and maximum network throughout supported by the various multimedia message centers respectively; and
selecting a multimedia message center with maximum current idle throughout according to the obtained current network throughout of the various multimedia message centers and the maximum network throughout supported by the various multimedia message centers.

3. The multimedia message transmitting method according to claim 1, wherein, the domain name system server selecting a multimedia message center from the various multimedia message centers comprises:
the domain name system server obtaining currently processed traffic of the various multimedia message centers and maximum processed traffic supported by the various multimedia message centers respectively; and
selecting a multimedia message center with a maximum current idle service processing capability according to the obtained currently processed traffic of the various multimedia message centers and the maximum processed traffic supported by the various multimedia message centers.

4. The multimedia message transmitting method according to claim 1, wherein, the domain name system server selecting a multimedia message center from the various multimedia message centers comprises:
the domain name system server obtaining current service processing delays of the various multimedia message centers respectively; and
selecting a multimedia message center with a minimum service processing delay according to the obtained current service processing delays of the various multimedia message centers.

5. The multimedia message transmitting method according to claim 1, wherein, the domain name system server selecting a multimedia message center from the various multimedia message centers comprises:
the domain name system server obtaining change conditions of currently processed traffic of the various multimedia message centers respectively; and
selecting a multimedia message center with a maximum reduction of the currently processed traffic according to the obtained change conditions of currently processed traffic of the various multimedia message centers.

6. A multimedia message transmitting device, comprising:
a multimedia message receiving unit, configured to receive multimedia message submitted by a multimedia message transmitting party;
a request transmitting unit, configured to transmit a multimedia message transmitting request to a domain name system server after the multimedia message receiving unit receives the multimedia message submitted by the multimedia message transmitting party;
an identification information receiving unit, configured to receive identification information of multimedia message centers returned by the domain name system server; and
a multimedia message transmitting unit, configured to transmit the multimedia message received by the multimedia message receiving unit to a multimedia message center identified by the identification information received by the identification information receiving unit.

7. The multimedia message transmitting device according to claim 6, wherein, the multimedia message transmitting device is a Wireless Application Protocol WAP gateway, a multimedia message transmitting device of a value-added service provider.

8. A domain name system server, comprising:
a request receiving unit, configured to receive a multimedia message transmitting request transmitted by a multimedia message transmitting device;
a selecting unit, configured to select a multimedia message center from various multimedia message centers after the request receiving unit receives the transmitting request; and
an identification information feedback unit, configured to feed back identification information of the multimedia message center selected by the selecting unit to the multimedia message transmitting device.

9. The domain name system server according to claim 8, wherein, the selecting unit specifically comprises:
a first obtaining sub-unit, configured to obtain current network throughout of the various multimedia message centers and maximum network throughout supported by the various multimedia message centers respectively; and
a first selecting sub-unit, configured to select a multimedia message center with maximum current idle throughout according to the current network throughout of the various multimedia message centers and the maximum network throughout supported by the various multimedia message centers obtained by the first obtaining sub-unit.

10. The domain name system server according to claim 8, wherein, the selecting unit specifically comprises:
a second obtaining sub-unit, configured to obtain currently processed traffic of the various multimedia message centers and maximum processed traffic supported by the various multimedia message centers respectively; and
a second selecting sub-unit, configured to select a multimedia message center with a maximum current idle service processing capability according to the currently processed traffic of the various multimedia message centers and the maximum processed traffic supported by the various multimedia message centers obtained by the second obtaining sub-unit.

11. The domain name system server according to claim 8, wherein, the selecting unit specifically comprises:
a third obtaining sub-unit, configured to obtain current service processing delays of the various multimedia message centers respectively; and
a third selecting sub-unit, configured to select a multimedia message center with a minimum service processing delay according to the current service processing delays of the various multimedia message centers obtained by the third obtaining sub-unit.

12. The domain name system server according to claim 8, wherein, the selecting unit specifically comprises:
a fourth obtaining sub-unit, configured to obtain change conditions of currently processed traffic of the various multimedia message centers respectively; and
a fourth selecting sub-unit, configured to select a multimedia message center with a maximum reduction of the currently processed traffic according to the change conditions of currently processed traffic of the various multimedia message centers obtained by the fourth obtaining sub-unit.
